(19) United States
(12) Patent Application Publication
(10) Pub. No.: US 2009/0051823 A1
(43) Pub. Date: Feb. 26, 2009

(54) REMOTE CONTROL APPARATUS AND REMOTE CONTROL METHOD

(75) Inventors: Takashi TSURUMOTO, Saitama (JP); Taketoshi SHIMIZU, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 12/034,537

(22) Filed: Feb. 20, 2008

(30) Foreign Application Priority Data
Feb. 20, 2007 (JP) P2007-039076

(51) Int. Cl. H04N 5/44

(52) U.S. Cl. 348/734; 348/E05.096

(57) ABSTRACT

A remote control apparatus for a remote control system using a wireless communication is disclosed. A second designation section designates a category of an electronic device as a pairing target. A transmission section broadcasts a signal which contains information representing the pairing and the category designated by the first designation section and the second designation section. A reception section receives a reply from an electronic device whose category is identical to the category represented by the information contained in the signal, the reply containing identification information of the electronic device and information which represents an electric field intensity of the signal received by the electronic device. A control section decides an electronic device which has transmitted a reply containing information which represents a maximum electric field intensity when a plurality of replies have been received.

### CROSS REFERENCES TO RELATED APPLICATIONS

The present invention contains subject matter related to Japanese Patent Application JP 2007-039076 filed in the Japanese Patent Office on Feb. 20, 2007, the entire contents of which being incorporated herein by reference.

### BACKGROUND OF THE INVENTION

1. Field of the Invention

The present invention relates to a remote control apparatus and a remote control method applied to a remote control for an electronic device, for example, according to a wireless communication system.

2. Description of the Related Art

When a home apparatus under control, for example, a television receiver, is remotely controlled through wireless communications using a 2.4 GHz ISM (Industrial, Scientific and Medical use) band, it has advantages of which it is less affected by obstructions than an infrared system and its communication distance is longer than that. In this remote control system, when a television receiver is newly bought and installed, a remote control apparatus (sometimes referred to as the remote commander) is necessary to be associated with the television receiver in one-to-one relationship (referred to as the pairing) to allow the remote control apparatus to control the television receiver. In particular, when the remote control system has another apparatus under control (composed of a communication section and an electronic device), the user is necessary to set his or her desired electronic device as a control target.

As shown in FIG. 1, even if another electronic device, for example, a television receiver 120, is present nearby, a remote commander 100 and a television receiver 110 are necessary to have been paired to allow the remote commander 100 to remotely control the desired television receiver 110. The pairing means that the ID (identification information) of the remote commander and that of the electronic device under control are exchanged therebetween. The ID is an address that identifies an electronic device. The ID for a group may be used. As the ID, a MAC (Message Authentication Code) address that is assigned when an electronic device is manufactured, an address created from an MAC address, or the like is used.

The pairing is performed by operating the remote commander 100. For example, by pressing a pairing button 101 of the remote commander 100 as shown in FIG. 2, the pairing process is performed.

In the past, as a communicable device finding method used in Bluetooth, HomeRF, or the like, a sub station finding message was transmitted as a broadcast message from the main station. A sub station that had received the sub station finding message transmitted a reply message. When the main station received the reply message, the main station was able to find a communicable device. In this case, since the sub station finding message was transmitted to all devices in the finding area, there was a problem of which the main station received reply messages from all devices other than the target device. To solve such a problem, Japanese Patent Application Laid-Open No. 2001-144781 (referred to as patent document 1) describes that when a sub station is found, the communicable range of the sub station finding message is changed.

In addition, it can be contemplated that information that represents the error rate of the sub station finding message received by an electronic device is inserted into the reply message of the electronic device and an electronic device that has transmitted a reply message containing information that represents the lowest error rate is considered as a control target. In this method, the remote commander is approached to an electronic device to be paired therewith and then the pairing button 101 is pressed.

### SUMMARY OF THE INVENTION

In the foregoing method of the related art, in the sub station finding process, the communicable range of the sub station finding message was narrowed and a sub station in the narrowed communicable range was detected as a communicable target. In this method, when there were a plurality of electronic devices in the narrowed communicable range, there was a problem of which an electronic device under control was difficult to be identified. There was also a problem of which an electronic device was difficult to be identified on the basis of information that represents an error rate. On the other hand, a remote commander that can control a plurality of electronic devices (so-called multi-remote controller) has been contemplated. In the remote commander of this type, since it was likely that the installation positions of the plurality of electronic devices under control were near, there were problems of which by the pairing method of the related art, a device under control was difficult to be identified and an electronic device to be paired was difficult to be identified during the pairing process.

In view of the foregoing, it would be desirable to provide a remote control system, a remote control apparatus, and an apparatus under remote control that allow a desired electronic device to be paired to be easily identified.

According to an embodiment of the present invention, there is provided a remote control apparatus for a remote control system using a wireless communication. The remote control apparatus includes a first designation section, a second designation section, a transmission section, a reception section, and a control section. The first designation section designates pairing. The second designation section designates a category of an electronic device as a pairing target. The transmission section broadcasts a signal which contains information representing the pairing and the category designated by the first designation section and the second designation section. The reception section receives a reply from an electronic device whose category is identical to the category represented by the information contained in the signal, the reply containing identification information of the electronic device and information which represents an electric field intensity of the signal received by the electronic device. The control section decides an electronic device which has transmitted a reply containing information which represents a maximum electric field intensity when a plurality of replies have been received.

According to an embodiment of the present invention, there is provided a remote control method for a remote control system using a wireless communication. Pairing is designated. A category of an electronic device is designated as a pairing target. A signal which contains information representing the pairing and the category that have been designated is broadcast. A reply is received from an electronic device whose category is identical to the category represented by the information contained in the signal. The reply contains identification information of the electronic device and information which represents an electric field intensity of the signal received by the electronic device. An electronic device which has transmitted a reply containing information which represents a maximum electric field intensity is decided when a plurality of replies have been received.

According to an embodiment of the present invention, there is provided a remote control method for a remote control system using a wireless communication. A category of an electronic device as a pairing target is designated. Pairing is designated. A signal which contains information representing the category and the pairing that have been designated is broadcast. A reply is received from an electronic device whose category is identical to the category represented by the information contained in the signal. The reply contains identification information of the electronic device and information which represents an electric field intensity of the signal received by the electronic device. An electronic device which has transmitted a reply containing information which represents a maximum electric field intensity is decided when a plurality of replies have been received.

According to embodiments of the present invention, when there are a plurality of electronic devices around the remote control apparatus (sometimes referred to as the remote commander), among them, one electronic device that is the closest to the remote commander and whose category matches that designated by the remote commander can be set as a remote control target. In addition, with the indication of the category of the electronic device selected as a pairing target, the electronic device as the paring target can be easily identified during the pairing process.

These and other objects, features and advantages of the present invention will become more apparent in light of the following detailed description of a best mode embodiment thereof, as illustrated in the accompanying drawings.

### BRIEF DESCRIPTION OF THE DRAWINGS

FIG. 1 is a schematic diagram describing the necessity of pairing;

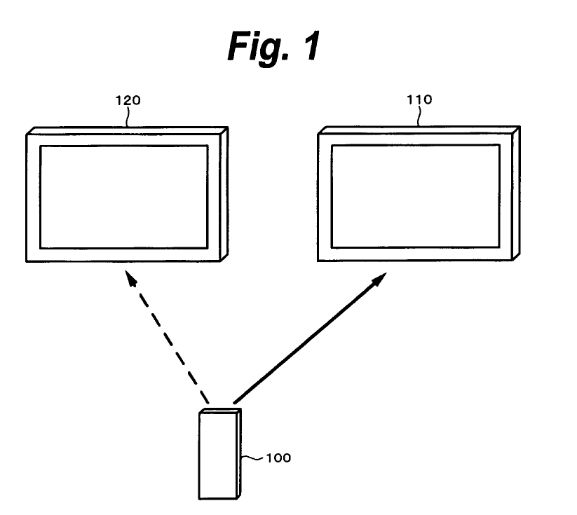

FIG. 2 is a schematic diagram describing a basic operation of pairing;

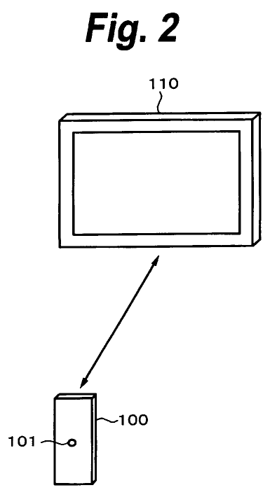

FIG. 3 is a schematic diagram describing a first method of identifying a pairing target;

FIG. 4 is a schematic diagram describing a second method of identifying a pairing target;

FIG. 5 is a schematic diagram describing an example of pairing of a so-called multi-remote controller that can remotely control a plurality of electronic devices;

FIG. 6 is a schematic diagram describing another example of pairing of a so-called multi-remote controller that can remotely control a plurality of electronic devices;

FIG. 7 is a flow chart showing a flow of processes performed among a remote commander, a television receiver, and a disc recorder in another example of pairing;

FIG. 8 is a front view showing appearance of a specific structure of a remote commander;

FIG. 9 is a partially enlarged view of FIG. 8;

FIG. 10 is a block diagram showing an outlined structure of a remote commander;

FIG. 11 is a block diagram showing an outlined structure with respect to a remote control of an apparatus under control;

FIG. 12 is a block diagram showing the structure of a transmission side for a remote control; and

FIG. 13 is a block diagram showing the structure of a reception side for a remote control.

### DETAILED DESCRIPTION OF THE PREFERRED EMBODIMENTS

Next, with reference to the accompanying drawings, an embodiment of the present invention will be described. This embodiment is applied for a remote control system that remotely controls a home electronic device. The remote control system is composed of one remote control apparatus (remote commander) and at least one apparatus under remote control (having a communication section and an electronic device). The remote control apparatus transmits remote control data according to a user's operation (the remote control data are sometimes referred to as a command). The apparatus under remote control receives a command from the remote control apparatus and performs an operation designated by the received command.

The electronic device includes an AV device such as a television receiver, a video recording/receiving device (specifically, a DVD (Digital Versatile Disc) player, a disc recorder, a VCR (Video Cassette Recorder), etc.), an audio recording/reproducing device (specifically, a CD player, an MD recorder, an audio amplifier, an FM tuner, etc.), a home electric alliance such as a refrigerator. The remote control apparatus is driven by an internal power supply whereas the apparatus under remote control is driven, for example, by a commercial power supply.

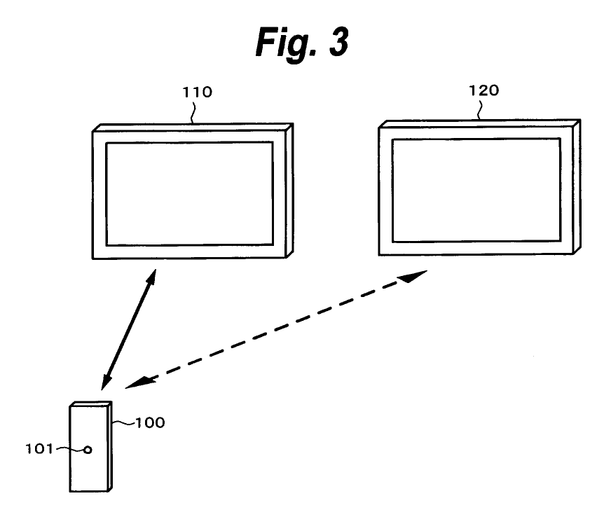

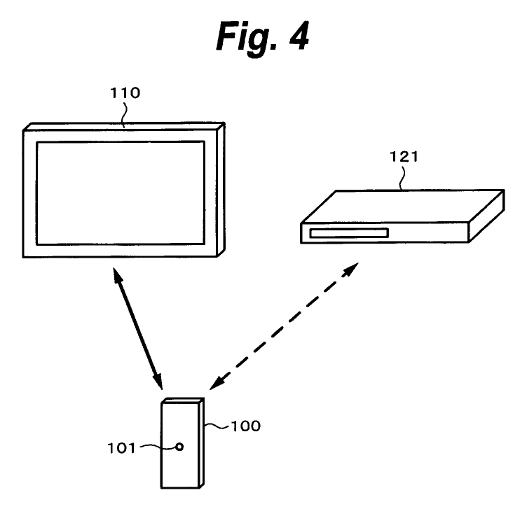

Next, with reference to FIG. 3 and FIG. 4, two methods of processes of identifying an electronic device as a pairing target according to this embodiment of the present invention will be described in brief. In FIG. 3, television receivers 110 and 120 are disposed around a remote commander 100 and the television receiver 110 to be designated as a control target is placed closer to the remote commander 100 than the television receiver 120.

In this case, when a pairing button 101 is pressed, the remote commander 100 broadcasts a message that contains the own ID and the television receivers 110 and 120 receives the message. When the television receivers 110 and 120 receive the message, they detect its error rate and transmit an acknowledge containing the error rate (hereinafter, this acknowledge is referred to as a reply) to the remote commander 100. The remote commander 100 determines that the television receiver 110 that has transmitted the reply containing lower error rate than that of the television receiver 120 be closer to the remote commander 100 than the television receiver 120 and registers the ID of the television receiver 110 as the target electronic device. Instead of the error rate, information that represents received electric field intensity may be used. The method of identifying the target electronic device based on whether the distance from the remote commander is far or near is the first pairing method.

FIG. 4 describes a second pairing method. It is assumed that the remote commander 100 is a remote commander dedicated for a predetermined electronic device, for example, a television receiver. When the pairing button 101 is pressed, the remote commander 100 broadcasts a message containing an own ID and a category code that represents a television receiver and the television receiver 110 and a disc recorder 121 receive the message. The category code contained in the received message is checked and it is determined whether or not the category code of the received message matches the category of the device that has received the message. In this case, since the category code contained in the transmission message is a television receiver, the television receiver 110 detects a match of the category codes. In contrast, the disc recorder 121 does not detect a match of the category codes.

The television receiver 110 that has detected a match of the category codes transmits a reply containing an own ID to the remote commander 100. In contrast, the disc recorder 121 that has not detected a match of the category codes doe not transmit a reply to the remote commander 100. Thus, the remote commander 100 receives the reply only from the television receiver 110 and registers an ID contained in the reply as a target electronic device. The category code that represents the type of an electronic device may be an existing commodity code, for example, a JAN (Japanese Article Number) code. Instead, a uniquely established code may be used. Instead, a maker code that represents a maker may be used together with the category code so as to identify the type of an electronic device in more detail.

According to this embodiment of the present invention, the first pairing method of identifying an electronic device as a pairing target based on whether the distance is far or near and the second pairing method of identifying an electronic device as a pairing target based on the category code are used in combination. In other words, an electronic device that has been determined to be the closest to the remote commander based on the error rate, electric field intensity, or the like and that has been detected to have a match of category codes is identified to be an electronic device as a pairing target. When two pairing methods are used in combination in such a manner, an electronic device can be easily identified to be a pairing target. In other words, even if an electronic device is difficult to be identified as a pairing target on the basis of the difference of distances, an electronic device can be identified to be a pairing target based on the category code. In addition, even if there are a plurality of electronic devices having the same category code, an electronic device can be identified to be a pairing target based on the difference of the distances.

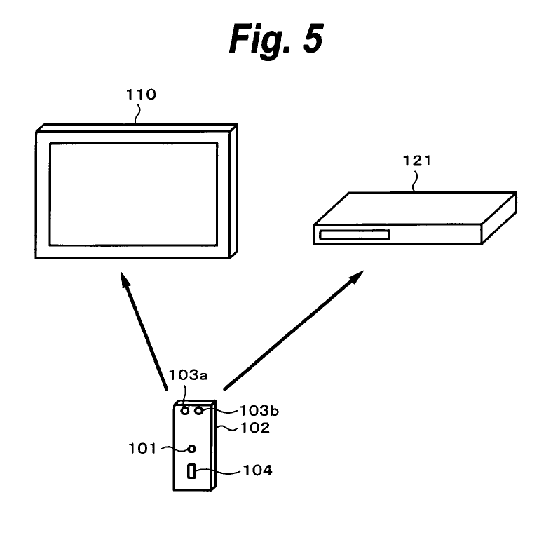

In particular, this embodiment is suitably applied for a remote commander (so-called multi-remote controller) that can remotely control a plurality of apparatus under remote control. As shown in FIG. 5, a remote commander 102 of multi-remote controller type has a television selection button 103a, a disc recorder selection button 103b, and an operation button 104 in addition to the pairing button 101. The number of device selection buttons is just exemplary. When three or more categories of electronic devices can be paired, three or more device selection buttons are disposed. An operation button 104 represents a set of a plurality of operation buttons such as a volume control button.

When one of the device selection buttons 103a and 103b is pressed to designate one of the television receiver 110 and the disc recorder 121 as a control target and then the pairing button 101 is pressed, the selected control target is paired. For example, when the television selection button 103a is pressed and then the pairing button 101 is pressed, the remote commander 102 is paired with the television receiver 110.

When the remote commander 102 is paired with an electronic device, the pairing button 101 may be pressed and then a device selection button may be pressed. For example, when the pairing button 101 is pressed and then the television selection button 103a is pressed, the remote commander 102 can be paired with the television receiver. When an electronic device is remotely controlled, after an electronic device is selected as a control target with a device selection button and the operation button 104 is operated, the selected electronic device can be remotely controlled.

The remote commander 102 has stored remote control codes with which it controls electronic devices of different models and different makers. The remote control codes have been stored in a nonvolatile memory of the remote commander 102, are obtained through the Internet and stored in the remote commander 102, or are learnt through a device under control and stored in the remote commander 102. Since it is likely that a plurality of electronic devices of different types are set as electronic devices under control, in this type of remote commander, it is preferred to narrow electronic devices under control based on category codes that represents models.

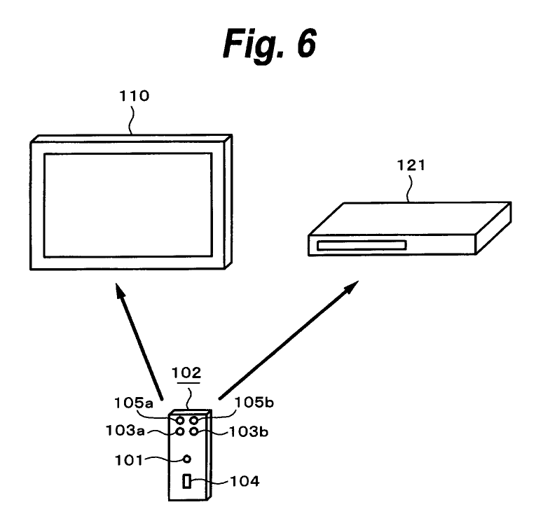

As shown in FIG. 6, the remote commander 102 has device selection indicators 105a and 105b composed, for example, of an LED (Light Emitting Diode) with which the user can readily recognize an electronic deice that he or she has selected with a device selection button. For example, when the television selection button 103a is pressed, the television selection indicator 105a lights (or blinks). (This lighting state applies to the following description.) When a button that can remotely control a television receiver is pressed, the television selection indicator 105a lights. When the disc recorder selection button 103b is pressed, the disc recorder selection indicator 105b lights.

As described above, in the pairing procedure of which the pairing button 101 is pressed first, to clarify the device that the user has selected, when the pairing button 101 is pressed, the device selection indicator 105a or 105b lights to prompt the user to operate the device selection button 103a or 103b. When the user presses a device selection button corresponding to the indicators that light, the remote commander 102 is paired with the device of the category. In other words, when the television selection button 103a is pressed, only the device selection indicator 105a lights and the pairing process is performed. This device selection indicator allows the user to readily recognize with which category of device the remote commander 102 is paired.

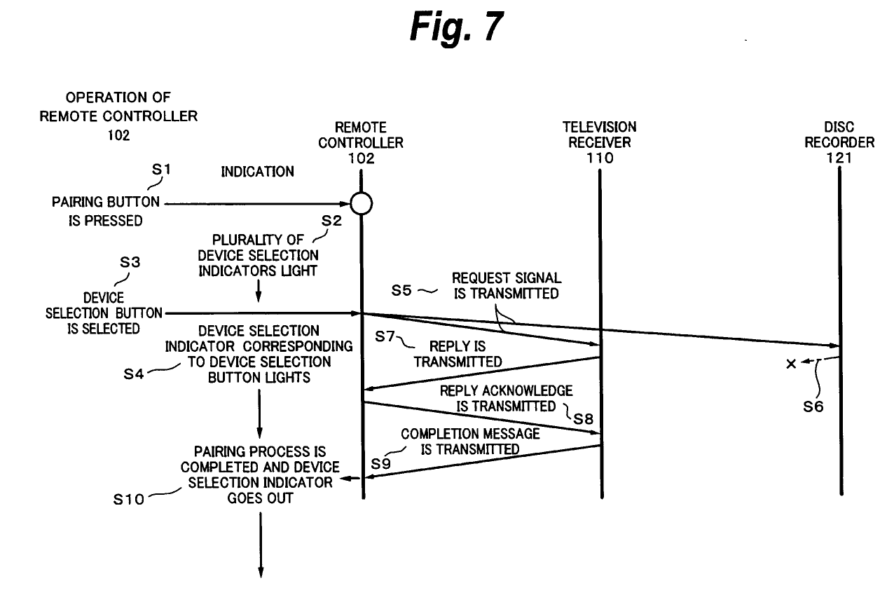

Next, a flow of processes for the structure shown in FIG. 6 will be described more specifically with reference to a sequence diagram shown in FIG. 7. First of all, the pairing button 101 of the remote commander 102 is pressed (at step S1). As a result, the plurality of device selection indicators 105a and 105b that represent devices with which the remote commander 102 can be paired light (at step S2). For example, the user presses the television selection button 103a (at step S3). The device selection indicator corresponding to the pressed device selection button lights (at step S4). For example, the television selection button 103a is pressed and thereby only the television selection indicator 105a light.

The remote commander 102 transmits a request signal (at step S5) and the television receiver 110 and the disc recorder 121 receive a remote commander signal. The request signal contains the category code of the device (television receiver) corresponding to the pressed device selection button, for example, the television selection button 103a. In this case, since the category code contained in the request signal does not represent the own category of the disc recorder 121, namely the disc recorder 121 does not detect a match of the category codes, it does not transmit a reply to the remote commander 102 (at step S6). In contrast, since the television receiver 110 detects a match of the category codes, it transmits a reply that contains the own ID and the error rate of the received request signal to the remote commander 102 that has transmitted the request signal (at step S7).

When the remote commander 102 has normally received the reply from the television receiver 110, the remote commander 102 transmits a reply acknowledge to the television receiver 110 (at step S8). When the remote commander 102 has received the reply acknowledge from the remote commander 102, the television receiver 110 transmits a completion message to the remote commander 102 to inform it that the television receiver 110 has registered the remote commander 102 as a pairing target (at step S9).

When the remote commander 102 has received the completion message, the television selection indicator 105a goes out to inform the user that the pairing process has been completed (at step S10). There may be two or more electronic devices that belong to the same category. In this case, at step S7, these electronic devices that belong to the same category each transmit a reply. An electronic device that has transmitted a reply containing information that represents the best error rate in the plurality of electronic devices is registered as a pairing target. At step S8, a reply acknowledge that contains the ID of an electronic device whose category code matches that of the request signal and that has the best error rate is transmitted to the target electronic device.

In such a manner, device selection indicators that indicate electronic devices that belong to categories that can be selected are disposed. The indicator corresponding to the pressed device selection button lights. After the pairing process has been completed, the indicator goes out. Thus, the user can readily recognize an electronic device as a pairing target. In addition, the user can readily know that the pairing process has been completed.

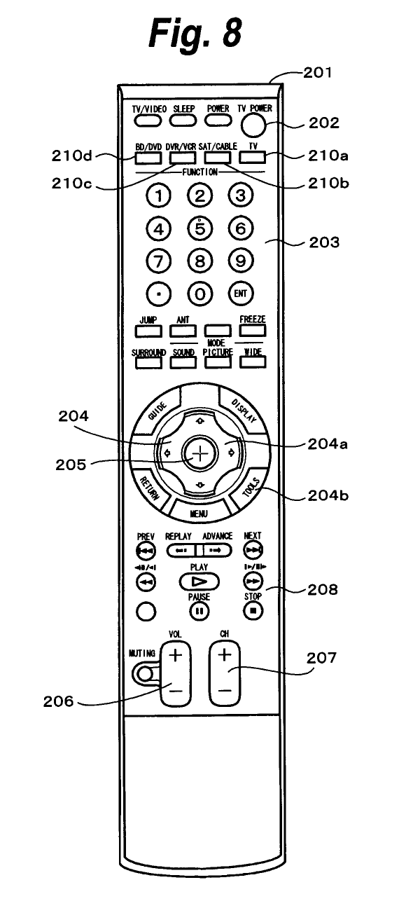

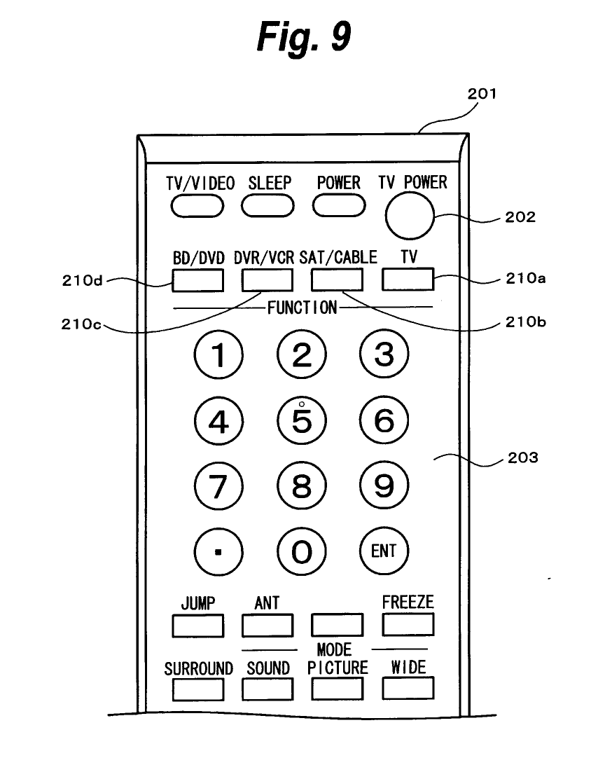

FIG. 8 shows an example of appearance of the remote commander 102. FIG. 9 is a partially enlarged view of the remote commander 102. A remote commander 201 shown in FIG. 8 and FIG. 9 has a power on/off button 202, a ten key portion 203, a directional key portion 204, a decision button 205, a volume adjustment button 206, a channel key 207, an operation key portion 208, and so forth. The remote commander 201 does not have a dedicated pairing button. When a right direction key 204a of the direction key portion 204 and a tool key 204b in a plurality of keys disposed around the directional key portion 204 are simultaneously pressed, their operations are treated as if the pairing button is pressed.

As shown in the enlarged view of FIG. 9, the remote commander 201 has device selection buttons 210a, 210b, 210c, and 210d. These buttons 210a to 210d are composed of a self-illuminative switch. When each of these buttons is pressed, it lights or goes out to indicate a selected function. The button 210a is a television selection button. The button 210b is a satellite broadcast tuner or cable television tuner selection button. The button 210c is a digital video or cassette VCR selection button. The button 210d is a DVD recorder or next generation disc (Blu ray disc) recorder selection button.

Instead of the foregoing structure, the remote commander may have a touch panel or an LCD (Liquid Crystal Display) that displays device selection indicators. In addition, the function selection buttons and the function selection indicators may not be corresponding to categories in one-to-one relationship. Instead, general purpose keys may be disposed and assigned predetermined functions.

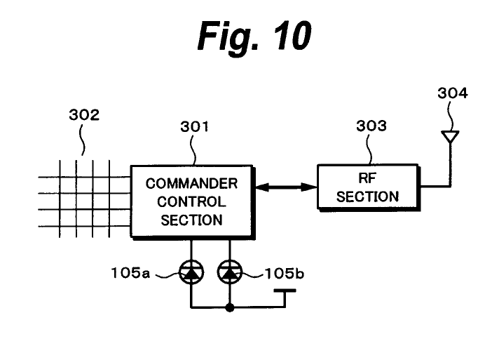

FIG. 10 shows the structure of principal sections of the remote commander 102. A key matrix 302 is connected to a commander control section 301 that has the structure of a microcomputer. The key matrix 302 detects which button of those of the remote commander has been pressed and supplies a detection signal to the commander control section 301. The key matrix 302 contains all buttons including the pairing button 101, the television selection button 103a, and the disc recorder selection button 103b. Connected to the commander control section 301 are device selection indicators including, for example, the television selection indicator 105a and the disc recorder selection indicator 105b. These selection indicators are caused to light or go out by the commander control section 301.

The commander control section 301 and an RF section 303 are connected. The RF section 303 and an antenna 304 transmit and receive data. For example, the commander control section 301 detects a button that is pressed on the key matrix 302, generates a signal corresponding to the button, transfers the signal (data) to the RF section 303, and transmits the signal as a radio wave to the target electronic device. As described with reference to FIG. 7, the pairing operation is performed on the basis of a button pressed in the key matrix 302 under the control of the commander control section 301. In addition to the transmission function, the RF section 303 has a function of receiving a transmission signal from an electronic device and supplying the received data to the commander control section 301.

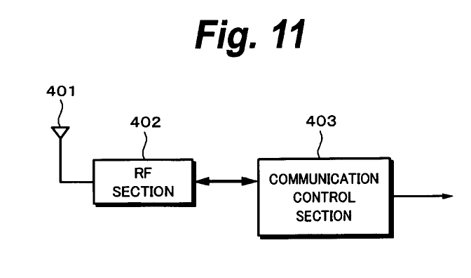

FIG. 11 shows a transmission and reception section disposed on the electronic device side. An antenna 401 and an RF section 402 transmit and receive data. Transmission data are supplied from a communication control section 403 having the structure of a microcomputer supplies to the RF section 402. Reception data are supplied from the RF section 402 to the communication control section 403. The pairing operation is performed by receiving a pairing request (request signal) as a radio wave signal under the control of the communication control section 403 as shown in FIG. 7. A control signal transmitted from the remote commander is received by the antenna 401 and the RF section 402, decoded as an operation signal by the communication control section 403, and then supplied to a device controller (not shown).

The RF section 303 of the remote commander and the RF section 402 of the electronic device can bidirectionally and wirelessly communicate with each other according to the same wireless communication system. As an example of the wireless communication system, the physical layer of IEEE (Instituted of Electrical and Electronics Engineers) 802.15.4 can be used. IEEE 802.15.4 is one of short distance wireless network standards and is called PAN (Personal Area Network) or W (Wireless) PAN.

The communication rate of this standard is in the range from several 10 kbps to several 100 kbps and the communication distance is in the range from several 10 m to several 100 m. In addition, the communication is performed in the unit of a frame. One frame is composed of a payload (0 to 127 bytes) and a header (6 bytes). Thus, the maximum size of one frame is 133 bytes. In this communication system, one of a plurality of transmission and reception systems can be used. In the remote control system according to this embodiment of the present invention, the simplest method of which the remote control apparatus transmits a command to the apparatus under remote control and the remote control apparatus receives a reply from the apparatus under remote control is used. Instead, a more complicated transmission and reception system than the foregoing system may be used. In this embodiment of the present invention, other bidirectional wireless systems other than the foregoing wireless system can be used.

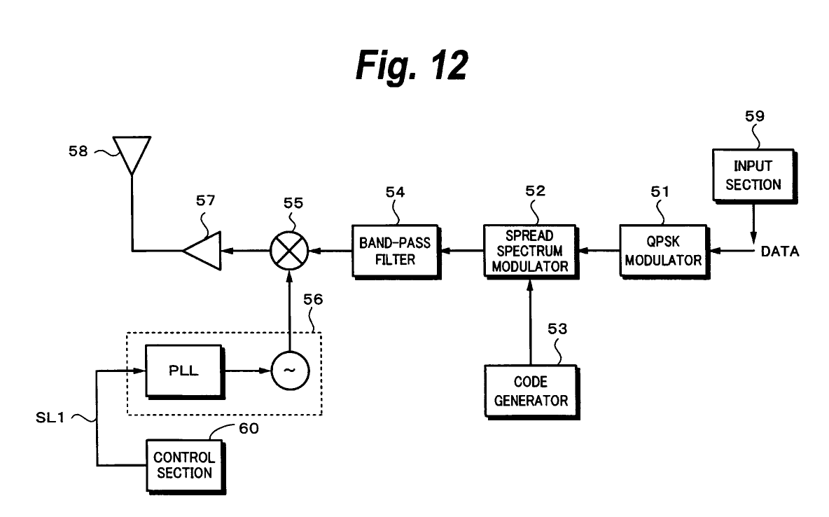

FIG. 12 shows the structure of a transmitter. Transmission data are supplied to a QPSK (Quadrature Phase Shift Keying) modulator 51 that modulates the transmission data according to the QPSK system. An output signal of the QPSK modulator 51 is supplied to a spread spectrum modulator 52. A spread code generated by a code generator 53 is supplied to the spread spectrum modulator 52. The spread spectrum modulator 52 spreads the supplied spectrum code according to the DSSS (Direct Sequence Spread Spectrum) system. As the spread code, a pseudo noise sequence is used. The DS (Direct Spread) system is an SS (Spectrum Spread) system of which phase modulation is performed with a high speed spread code to spread the spectrum of the signal.

An output signal of the spread spectrum modulator 52 is supplied to a multiplying device 55 through a band-pass filter 54. Supplied to the multiplying device 55 is a local oscillation signal supplied from a local oscillator 56 having the structure of a PLL (Phase Lock Loop). The multiplying device 55 generates a transmission signal that has been up-converted into a 2.4 GHz frequency band. The transmission signal is supplied to an antenna 58 through an amplifier 57 and then transmitted. The transmission output can be changed by controlling the gain of the amplifier 57.

Sixteen communication channels are set starting from 2.405 GHz at intervals of 5 MHz, namely 2.410 GHz, 2.415 GHz, . . . and 2.480 GHz. In this embodiment, a plurality of frequency channels, for example, three frequency channels, that do not overlap with frequencies for the wireless LAN are used in these 16 frequency channels. A channel is set by adjusting the local oscillation frequency that the local oscillator 56 outputs with a channel selection signal SL1. The selection signal SL1 is output from a control section 60.

The control section 60 is a microcomputer composed, for example, of a CPU (Central Processing Unit), a ROM (Read Only Memory), a RAM (Random Access Memory), and so forth. The control section 60 totally controls each section of the transmitter by executing a program stored in the ROM or the like.

Disposed in the transmitter of the remote commander is an input section 59 that includes keys, switches, buttons and/or a touch panel to remotely control an electronic device. A command corresponding to an operation to the input section 59 is transmitted to the electronic device. When the electronic device has normally received the command, the electronic device transmits a reply to the remote commander.

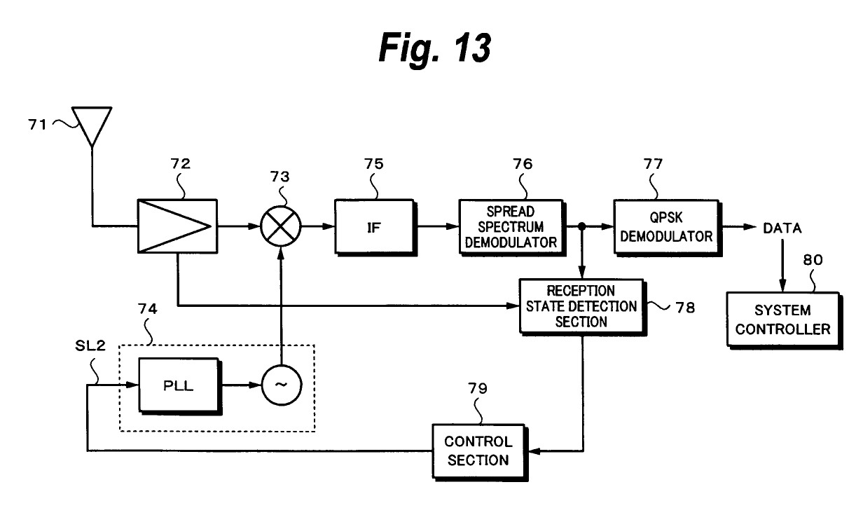

FIG. 13 shows the structure of the receiver. A signal received by an antenna 71 is supplied to an LNA (Low Noise Amplifier) 72. The antenna 71 is normally used in common with the antenna 58 of the transmitter. The transmitter or the receiver is selected by a transmission and reception selection switch. An output signal of the LNA 72 is supplied to a multiplying device 73. A local oscillation signal is supplied from a local oscillator 74 having the structure of a PLL (Phase Lock Loop) to the multiplying device 73. The multiplying device 73 generates a down-converted intermediate frequency (IF) signal.

The IF signal is supplied to a spread spectrum demodulator 76. The spread spectrum demodulator 76 demodulates the reception signal by correlating the reception signal with a reference spread code generated on the reception side. When the timings of the reception signal and the reference spread code do not accurately match, a correct correlation value is not obtained. When communication starts, the reception side finds the timings and holds the found timing. To find the timings, a correlator, such as a matched filter, is used.

A demodulation signal is supplied from the spread spectrum demodulator 76 to a QPSK demodulator 77. The QPSK demodulator 77 demodulates the supplied signal according to the QPSK system and obtains reception data. In the electronic device, the reception data are a command. The command is supplied to a system controller 80 of the electronic device. The command is used to control the operation of the electronic device. In the remote commander, the reception data are a reply and the received reply is supplied to a control section 79.

The control section 79 is a microcomputer composed, for example, of a CPU (Central Processing Unit), a ROM (Read Only Memory), a RAM (Random Access Memory), and so forth. The control section 79 totally controls each section of the receiver by executing a program stored in the ROM or the like. Specifically, the control section 60 of the transmitter and the control section 79 of the receiver are structured in common. The commander control section 301 shown in FIG. 10 or the communication control section 403 shown in FIG. 11 corresponds to the control sections 60 and 79.

The demodulation signal supplied from the spread spectrum demodulator 76 and the output signal of the LNA 72 are supplied to a reception state detection section 78. The reception state detection section 78 has functions of receiving a frame, for example, a pairing request signal, calculating a link quality indicator (LQI) based on the intensity of the signal and the intensity of the noise interference, and informing the upper level of the physical layer of LQI. LQI is prescribed in the physical layer of IEEE 802.15.4 and represented as the value of digital data. LQI is the value corresponding to the error rate. LQI is supplied to the control section 79. LQI calculated by the reception state detection section 78 of the receiver of the electronic device is transmitted to the remote commander along with the reply.

A channel selection signal SL2 that the control section 79 generates controls the local oscillator 74 and causes a predetermined frequency channel that is less affected by the microwave oven to be selected from a plurality of different frequency channels.

It should be understood by those skilled in the art that various modifications, combinations, sub-combinations and alternations may occur depending on design requirements and other factors insofar as they are within the scope of the appended claims or the equivalents thereof. For example, the wireless communication method may be based on other than IEEE 802.15.4.

What is claimed is:

1. A remote control apparatus for a remote control system using a wireless communication, comprising:
first designation means for designating pairing;
second designation means for designating a category of an electronic device as a pairing target;
transmission means for broadcasting a signal which contains information representing the pairing and the category designated by the first designation means and the second designation means;
reception means for receiving a reply from an electronic device whose category is identical to the category represented by the information contained in the signal, the reply containing identification information of the electronic device and information which represents an electric field intensity of the signal received by the electronic device; and
control means for deciding an electronic device which has transmitted a reply containing information which represents a maximum electric field intensity when a plurality of replies have been received.

2. The remote control apparatus as set forth in claim 1,
wherein after the pairing is designated by the first designation means, the category is designated by the second designation means.

3. The remote control apparatus as set forth in claim 1,
wherein after the category is designated by the second designation means, the pairing is designated by the first designation means.

4. The remote control apparatus as set forth in claim 1, further comprising:
indication means for indicating the category designated by the second designation means.

5. A remote control method for a remote control system using a wireless communication, comprising the steps of:
designating pairing;
designating a category of an electronic device as a pairing target;
broadcasting a signal which contains information representing the pairing and the category that have been designated;
receiving a reply from an electronic device whose category is identical to the category represented by the information contained in the signal, the reply containing identification information of the electronic device and information which represents an electric field intensity of the signal received by the electronic device; and
deciding an electronic device which has transmitted a reply containing information which represents a maximum electric field intensity when a plurality of replies have been received.

6. A remote control method for a remote control system using a wireless communication, comprising the steps of:
designating a category of an electronic device as a pairing target;
designating pairing;
broadcasting a signal which contains information representing the category and the pairing that have been designated;
receiving a reply from an electronic device whose category is identical to the category represented by the information contained in the signal, the reply containing identification information of the electronic device and information which represents an electric field intensity of the signal received by the electronic device; and
deciding an electronic device which has transmitted a reply containing information which represents a maximum electric field intensity when a plurality of replies have been received.

7. The remote control method as set forth in claim 5 or claim 6,
wherein after the category designating step, an indication which identifies the designated category is performed.

8. A remote control apparatus for a remote control system using a wireless communication, comprising:
a first designation section which designates pairing;
a second designation section which designates a category of an electronic device as a pairing target;
a transmission section which broadcasts a signal which contains information representing the pairing and the category designated by the first designation section and the second designation section;
a reception section which receives a reply from an electronic device whose category is identical to the category represented by the information contained in the signal, the reply containing identification information of the electronic device and information which represents an electric field intensity of the signal received by the electronic device; and
a control section which decides an electronic device which has transmitted a reply containing information which represents a maximum electric field intensity when a plurality of replies have been received.
